(19) United States
(12) Patent Application Publication
(10) Pub. No.: US 2023/0266252 A1
(43) Pub. Date: Aug. 24, 2023

(54) APPARATUS AND METHOD FOR ANALYSIS OF A MOVING SLURRY

(71) Applicant: BLUE CUBE TECHNOLOGY (PTY) LTD, Stellenbosch (ZA)

(72) Inventors: Francois Eberhardt DU PLESSIS, Stellenbosch (ZA); Petrus Albertus LE ROUX, Rawsonville (ZA)

(21) Appl. No.: 18/010,770

(22) PCT Filed: Jun. 22, 2021
(86) PCT No.: PCT/IB2021/055479

§ 371 Date: Dec. 15, 2022

(30) Foreign Application Priority Data
Jun. 22, 2020 (GB) 2009498.3

(51) Int. Cl. G01N 21/85; G01N 15/14; G01N 15/02

(52) U.S. Cl. CPC G01N 21/85; G01N 15/1434; G01N 15/0227; G01N 15/1463; G01N 2015/1493; G01N 2015/0294; G01N 2015/0053

(57) ABSTRACT

Means for analysis of a moving slurry of solid particles in a liquid medium that comprises: causing the slurry to flow with fully developed turbulence in a vertical pipe such that the flowing slurry fills the entire cross-section of the pipe; providing a transparent window in a wall of the pipe, said window being flush with an inside of the pipe; emitting light from a light source through the window, onto the flowing slurry inside the pipe in an examination zone; taking a plurality of individual measurements of individual solid particles in the flowing slurry by collecting light returned from the examination zone; collating the results of a statistically significant number of the individual measurements to provide a characteristic of the flowing slurry, as a whole.

### FIELD OF THE INVENTION

This invention relates to real-time analysis of moving slurries for industrial processes where slurries of solids particles suspended in liquids, are transported by pipe. The invention is particularly beneficial in the minerals processing industry.

### BACKGROUND TO THE INVENTION

A “slurry” typically contains solid particles (and some gas bubbles) suspended in a moving liquid like water and there is a basic, age-old need in industry to know, in real time, information about the contents of a slurry moving through a pipe. By knowing at least some information about the slurry contents in real time, action can also be taken quickly (preferably in real time) by industries to respond to changes in the slurry contents and maximise their operational benefits.

Typical information about slurry contents includes but is not limited to: elemental composition, mineral composition, particle size distribution, particle shapes, other particle characteristics, percentage solids and percentage gas.

Examples of the actions that could be taken in industry, if information about slurry contents were available quickly, include:
1. The slurry can be diverted according to its contents to the most suitable container or process;
2. Manipulated Variables (MVs) of a process that produces the slurry can be adjusted by automatic or manual feedback control to keep a chosen Process Variable (PV) given by the known slurry contents, within specification; and/or
3. Adjusting the recipe of a following process based on the known slurry contents.

The typical benefits that such industries may reap from real time information about the contents of a slurry moving through a pipe, includes:
1. Increased production volume due to higher yield/recovery with the same inputs;
2. Stable operation with consistent quality/grade production that may enable a higher selling price or reduced risk of penalties per unit produced;
3. Decreased production costs due to less time, energy, material or human intervention required; and
4. Lower operational risk due to better informed decisions.

Current practices to determine slurry contents typically include analysing a sample of a flowing slurry, e.g. by conducting laboratory tests or by applying spectroscopic analysis to the sample. An example of current spectroscopic analysis conducted on a flowing slurry is represented in FIG. 1A. A low number of very precise measurements are taken of subtle, small differences of a very large number of particles. In this example, spectral analysis of a flowing slurry is conducted through a window by passing an illumination beam of 10 mm by 7 mm onto the flowing slurry. Hundreds of micron-sized particles are visible simultaneously in this illumination zone. The slurry flows at a typical speed of 2 m/s and measurements are averaged over 15 seconds, so that the effective area under measurement is 210,000 mm². Typically more than a million particles are visible during the 15 second period over which spectral analysis results are averaged.

Current practices to determine slurry contents all have one or more of the following disadvantages:
1. Some practices extract samples or divert a sub-stream from the production stream, sometimes incorporating dilution or concentration, leading to sampling bias, complexity of extra slurry manipulation, time delay to prepare the sub-stream for analysis and cost of disposal or recirculation of extracted slurry;
2. Some practices aim to measure changes in the contents in a slurry, of small (trace) components, and their effect on the bulk average signal of the slurry, leading to poor detection limits due the small effect of such components on the bulk average; and
3. Some practices measure directly on a slurry flowing in a pipe, as a whole, but ignore possible bias due to different particle sizes and shapes.

Even if measurements are taken in real time on samples diverted in sub-streams, the measurements are subject to sampling bias and the complexity of slurry manipulation. These disadvantages are unavoidable in all currently known techniques to take measurements on opaque process streams such as slurries that require light or other radiation to pass through the sample.

The present invention seeks to provide real time information about the contents of a bulk process stream in the form of a slurry flowing in a pipe, which overcomes at least to some extent, the disadvantages of current practices mentioned above.

### SUMMARY OF THE INVENTION

According to a first aspect of the present invention there is provided a method for analysis of a moving slurry, said method comprising:
causing the slurry to flow with fully developed turbulence in a vertical pipe, such that the flowing slurry fills the entire cross-section of the pipe;
providing a transparent window in a wall of the pipe, said window being flush with the inside of the pipe;
emitting light from a light source through the window, onto the flowing slurry inside the pipe in an examination zone;
taking a plurality of individual measurements of individual solid particles in the flowing slurry by collecting light reflected from the examination zone;
collating the results of a statistically significant number of the individual measurements to provide a characteristic of the flowing slurry, as a whole.

The term “smooth”, as used in this specification with reference to a pipe, means that the inside of the pipe is substantially free from disturbances such as surface anomalies, bends, changes in diameter, or the like.

The term “pipe” as used herein, includes a whole pipe, but also includes a part or section of a pipe.

The term “vertical” as used herein includes an orientation that is perfectly vertical, but also includes orientations that deviates from perfect vertical by a small degree.

The term “statistically significant” as used herein, means that the number of measurements evaluated is high enough to provide a predetermined degree of precision of the calculated characteristics with an uncertainty better than chance. By way of example, if 40,000 particles of the bulk are classified by individual measurement, then 1.0% of the bulk occurrence of a specific class of particle will result in 400 positive classifications, typically with a standard deviation of ±20 particles (an uncertainty of ±0.05%), meaning that 40,000 measurements provides an ability to differentiate statistically significantly between a 1.0% and a 0.9% occurrence of a particle class in the bulk.

The light source may be pulsed on for short enough periods of time so that the distance of movement of particles over said time period is less than the maximum expected diameter of said particles.

The light collection may be integrated for short periods of time so that the distance of movement of particles over said time period is less than the maximum expected diameter of said particles.

The light source may be directed at an acute angle relative to the axis of light collection to the examination zone.

A multiple of light sources, each with a different range of wavelengths, may be used to illuminate the examination zone, each from a different direction, so that the light of the different light sources overlaps in the examination zone.

The light source may be focused to an area in the examination zone that is smaller than the largest particles expected to be present.

The light source pulse energy may be high enough to cause light induced breakdown of particle surface to a state of plasma.

The light source may be directed through immersion oil instead of air to the transparent window in the wall of the pipe in order to minimise reflections from said window, light loss, and stray light.

The light source may be directed through an optical medium with high index of refraction, machined and polished to a shape to achieve close optical contact with the transparent window and with a machined second surface orthogonal to the light source direction, to minimise reflection.

Each light source may be directed through a prism with one surface that is in close optical contact with the transparent window and a second surface orthogonal to the light source direction, in order to minimise reflections from said window, light loss, and stray light.

The light source may be a coherent monochromatic beam size sufficiently large enough to cover the examination zone and be partially reflected from the window to serve as a reference beam for digital holography where the light reflected from both the examination zone and partially reflected from the window is collected by a 2-dimensional image sensor without lenses, to capture the interference patterns for further digital holography signal processing.

The light may be collected by a lens assembly and focused on a 2-dimensional image sensor with small enough pixels to differentiate between individual particles.

The two-dimensional image sensor may provide multispectral output.

The light may be collected by a lens assembly and focused on a one-dimensional hyper-spectral image sensor with small enough pixels to differentiate between individual particles, where a two-dimensional hyper-spectral image may be built up by recording a high number of line images from the slurry moving past the sensor, in the manner of a push-broom imager.

The method may include taking a plurality of consecutive digital images of the flowing slurry and analysing the digital images with digital image processing methods to identify the two-dimensional size of individual particles, and the results of enough particles from enough images may be combined to result in a statistically significant representation of the bulk slurry particle size distribution.

Digital image processing methods may be used to analyse the shape of individual particles, and the results of enough particles from enough images may be combined to provide in a statistically significant representation of the bulk slurry particle shape distribution.

A multi-spectral image may be obtained and digital image processing methods may be used to identify the spectral intensities of individual particles.

A multi-spectral image may be obtained and the spectral intensities of the light source may be determined from the specular reflectance off bubbles, to serve as reference spectral intensities and thus enable the calculation of relative diffuse spectral reflectance for individual particles.

The material of each particle may be identified according to the geometric distance between its relative diffuse spectral reflectance and the closest relative diffuse spectral reflectance of reference materials as stored in a table and a high enough number of results may be collated to provide a statistically significant representation of the bulk slurry solids content material composition.

The total particle surface summed over a large number of images may be calculated as a fraction of the sum of surface areas of all images and the results may then serve as a monotonically rising indicator of the fraction of solids in the slurry.

The total surface of identified bubbles summed over a large number of images may be calculated as a fraction of the sum of surface areas of all images and the results may then serve as a monotonically rising indicator of the fraction of gas in the slurry.

The light may be collected by a lens assembly and directed to a spectrometer with digital output.

The method may include directing the light from the light source and light returned from the examination zone co-axially in opposite directions and separating them by use of a partially reflecting mirror at an acute angle to the average light axis.

The method may include taking a plurality of consecutive digital spectrographs of an examination zone in the flowing slurry and analysing each digital spectrograph with chemometric methods to identify the most likely material that was in the examination zone during the time that the spectrograph was taken and then classifying the result as a solid particle type, gas bubble or transporting liquid for a high enough number of measurements to produce a statistically significant representation of the bulk slurry composition.

The total fraction of spectrographs classified as solids particles may be calculated and the result may then serve as a monotonically rising indicator of the fraction of solids in the slurry.

The method may include compensating by machine learning, by adjusting the results based on laboratory analysis of bulk samples taken during a multiple of measurements, in order to compensate for possible non-linear effects and presentation bias, when calculating the characteristic of the flowing slurry, as a whole.

The method may include using a wavelength area that is shorter than the primary light source wavelength in a Stokes Raman analyser, by adding a long pass dichroic mirror with a cut-on wavelength below that of the primary light source, into the primary light source path.

The method may include adding a lens camera behind said long pass dichroic mirror, said lens camera being configured to capture an image of the analysis area.

The method may include providing a polarised beam splitter and secondary collimated light source that are configured to emit wavelengths that include wavelengths that are shorter than the wavelengths of the primary light source, in order to illuminate the area of analysis.

The secondary light source may have an etendue that is lower than the primary light source, in order to increase its spot size at the examination zone.

The method may include using a secondary light source with a slightly unfocussed collimator in order to increase its spot size at the examination zone.

The pipe may be straight for a length of at least eight times the diameter of the pipe.

The slurry may flow upwards in the pipe.

The pipe may be straight, smooth and is free from disturbances.

The maximum expected dimensions of solid particles in the slurry may be less than 2% of the diameter of the pipe.

According to another aspect of the present invention there is provided apparatus for analysis of a moving slurry of solid particles in a liquid medium, said apparatus comprising:
a transparent window that is flush with an inside of a wall of a vertical pipe
a light source that is configured to emit light from an outside of the window, through the window, onto a slurry flowing inside the pipe in an examination zone;
measuring apparatus configured for taking a plurality of individual measurements of individual solid particles in the flowing slurry by collecting light from the examination zone; and
a processor configured for collating the results of a statistically significant number of the individual measurements to provide a characteristic of the flowing slurry, as a whole.

The apparatus may be used in a method as described hereinabove.

### BRIEF DESCRIPTION OF THE DRAWINGS

For a better understanding of the present invention, and to show how it may be carried into effect, the invention will now be described by way of non-limiting example, with reference to the accompanying drawings in which:

FIG. 1A is a diagrammatic representation of using spectral analysis to monitor a flowing slurry according to the prior art;

FIG. 1B is a diagrammatic representation of the methods of the present invention, for comparison to the prior art;

FIG. 2 is a longitudinal section through one embodiment of apparatus according to the present invention, for analysis of a moving slurry;

FIG. 3 is a detail sectional view taken at III-III through the sapphire window shown in FIG. 2;

FIG. 4 is a diagrammatic representation of illumination in the examination zone in the apparatus of FIG. 2;

FIG. 5A to 5E shows detail of area V of the apparatus of FIG. 2 as well as 4 variations thereto;

FIG. 6 is a sectional view taken at VI-VI, through the instrument housing of FIG. 5B;

FIG. 7 is a diagrammatic representation of a dichroic colour splitter for use in the present invention;

FIG. 8 is a diagrammatic representation of illumination and spectral analysis according to a second embodiment of the present invention;

FIG. 9 is a diagrammatic representation of an expanded variation on the illumination and spectral analysis of FIG. 8;

FIG. 10 shows an image (photograph) of apparatus used in experimental implementation of the illumination and spectral analysis of FIG. 8;

FIG. 11 shows experimental results obtained using the apparatus of FIG. 8 and prior art method of FIG. 1A; and

FIG. 12 shows experimental results obtained using the apparatus and method of FIG. 8.

### DETAILED DESCRIPTION OF THE DRAWINGS

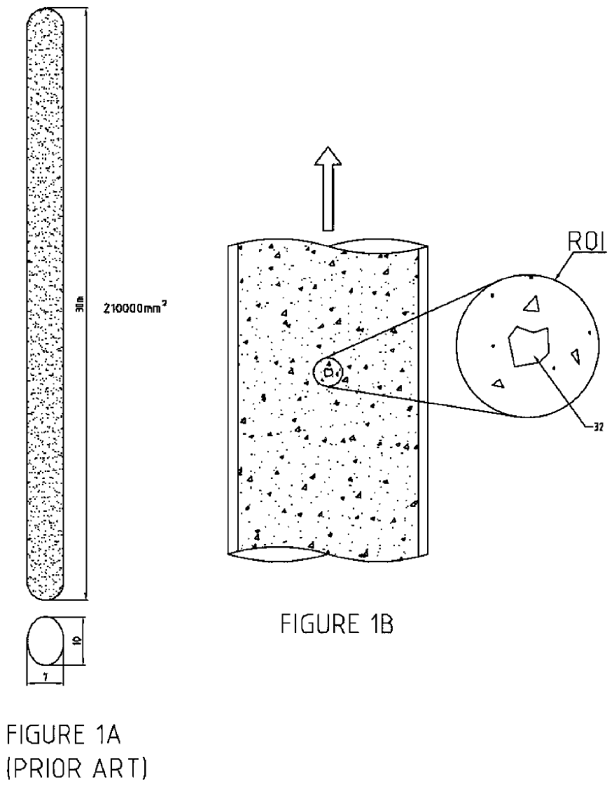

Referring to FIG. 1B, in contrast to the prior art shown in FIG. 1A, it was found in the present invention that by doing conceptually the opposite of the prior art, more precise measurements can be obtained, e.g. by increasing the number of measurements by 5 magnitudes of 10, decreasing the area under measurement by 9 magnitudes of 10 and reducing the period of measurement by 8 magnitudes of 10 (typically 50,000 individual measurements of an area with diameter of tens of μm over a time of 1 μs). In FIG. 1B, the examination zone or region of interest (ROI) that is examined in an individual measurement is shown and it indicates an individual particle 32, which is analysed independent from adjacent particles.

The present invention does not depend on a very precise and difficult quantification of a small number of measurements of the average of a high number of particles, as done in the prior art and as shown in FIG. 1A, but rather depends on the relatively simpler identification (classification) of a high number of measurements of individual particles and aggregating the measurements into one result.

The present invention relies on the following assumptions, which have been supported by experimental data, that:
1. minerals at a small enough scale are not mixed, but occur as small crystals of individual minerals and can therefore be classified;
2. classification of materials, also known as identification, is considerably easier to perform than quantification, but can only be performed where such materials are not mixed but are at least somewhat liberated from each other; and
3. a bias in results occurs where there is a bias in particle size according to mineral or material.

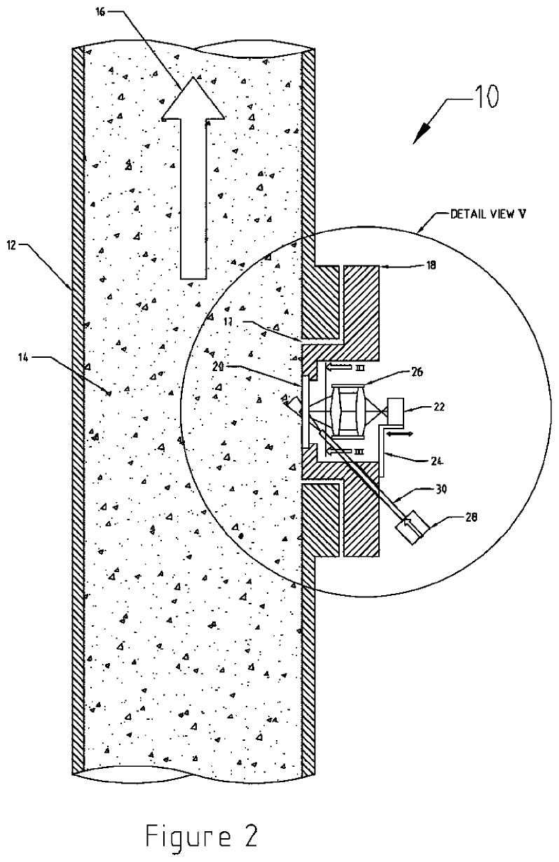

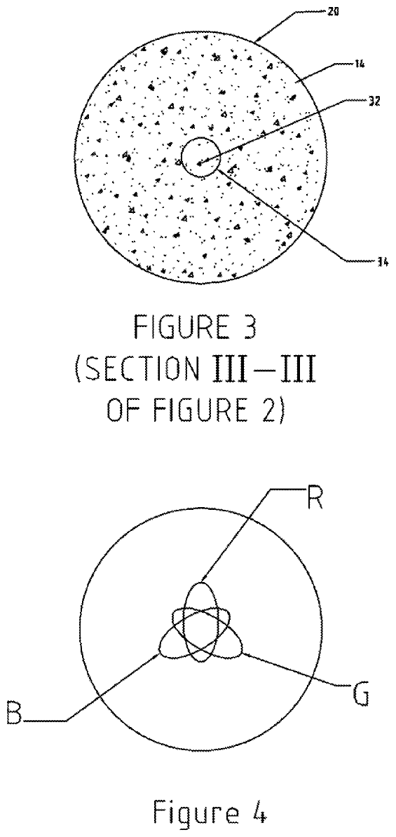

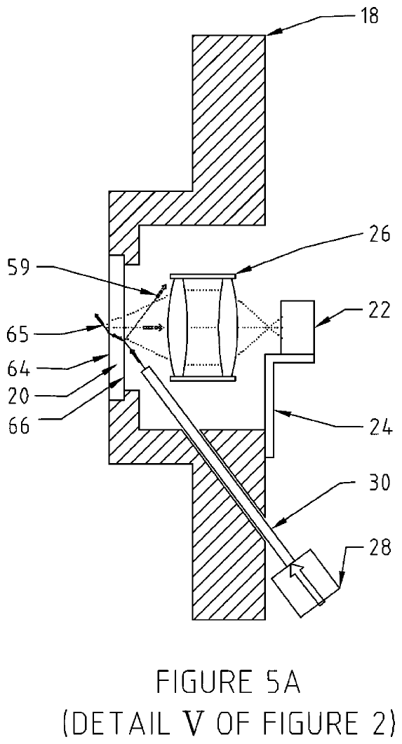

Referring to FIGS. 2-7, a first embodiment of apparatus for analysis of a moving slurry according to the present invention, is generally identified by reference number 10.

The apparatus 10 is installed on a vertical pipe 12 in which a slurry 14 flows and the slurry preferably flows upwards, as shown by reference arrow 16. The slurry 14 comprises small solid particles suspended in a liquid and also includes some gas bubbles. The slurry 14 fills the entire cross-section of the pipe 12. The pipe 12 is straight and smooth and preferably has a straight length of at least eight times the diameter of the pipe. The flow rate of the slurry 14 is such that it flows in the pipe 12 with fully developed turbulence and the dimensions of the particles in the slurry are less than 2% of the pipe diameter. It has been found that if these conditions are met, characteristics of the part of the slurry 14 flowing past the apparatus (through an examination zone—see below) are representative of the slurry across the pipe 12.

The wall of the pipe 12 defines an opening 17 in which an instrument housing 18 of the apparatus 10, can be installed in a watertight manner. The instrument housing 18 supports a transparent window 20, preferably of an abrasion resistant material such as sapphire, such that the faces of the instrument housing and sapphire window are flush with the inside of the pipe 12, so as to cause no significant disturbance to the flow of the slurry 14 past the sapphire window.

The apparatus 10 further includes a monochrome camera 22, supported on a mounting 24 and an objective lens assembly 26, such that the camera can capture images of the slurry 14 flowing past the sapphire window 20 and store the images digitally for analysis by a computer. The mounting 24 allows the camera 22 and/or objective lens 26 to be moved to focus on the slurry flowing inside the pipe 12 past the face of the sapphire window 20.

The objective lens assembly 26 is configured to collect light from a very small region inside the slurry 14, in front of the sapphire window 20 (the examination zone) and projecting the light as an image into the imaging sensor of the camera 22.

The apparatus 10 further includes at least one light source 28 for illuminating the slurry 14 flowing past the face of the sapphire window 20. A light guide 30 such as an optical fibre, may be used to direct the light from the source to the slurry.

The light source 28 is preferably a flash illumination source, capable of generating a light pulse of short enough duration and adequate intensity to capture a stationary image of the moving solid particles in the slurry 14 in the examination zone. The light emitted by the light source 28 is of a suitable numerical aperture (NA) to illuminate the entire examination zone without obstructing the optical path of the camera and without projecting excessive light outside of the examination zone.

As shown more specifically in FIGS. 4 and 6, the apparatus 10 preferably includes multiple flash light sources 28, each with a separate light guide and in a preferred embodiment, the light sources emit different wavelength ranges of light (e.g. red, green and blue light, respectively) from different angles, such that the light from all three sources illuminate the examination zone. The three light beams of different wavelength ranges are identified in FIG. 4 as R—red, G—green, and B—blue. A mechanism is provided to synchronise the light sources 28 and the camera 22 in such a way to emit a flash of light simultaneously from each light source for each period of exposure of the camera.

Instead of using a monochrome camera 22, the camera can be a hyper-spectral line camera with small enough pixels to differentiate between individual particles, where a 2-dimensional hyper-spectral image is built up by recording a high number of line images from the slurry moving past the sensor, in the manner of a push-broom imager.

Instead of using a monochrome camera 22, the camera can be a multi-spectral camera with two or more wavelength ranges. The use of different wavelength ranges of light, emitted from different angles onto the solid particles 32 in the examination zone, which concurs with at least some of the wavelength ranges of the multispectral camera, can assist in showing the three-dimensional shapes of the particles, by use of colour photometric stereoscopy.

The angle between the optical axis of each illumination source, i.e. the angle at which light is emitted from each light guide 30 to the examination zone, and the common optical axis of the camera 22 and objective lens assembly 26, is preferably as large as possible to accentuate the colour photometric stereoscopy effect however not so large as to cause excessive reflection of light from the light source 28 off of the sapphire window 20 interfaces, either on the light source side 66 or the slurry side 64. Such reflections due to large angles are more pronounced for large differences between optical media indexes of refraction, as illustrated by reflected light 59.

The numerical aperture and f-stop of the objective lens assembly 26 and camera 22 are preferably used to restrict the depth of field in the part of the examination zone that is being photographed, i.e. the examination zone 34 for which a digital image is captured.

In embodiments where the camera 22 is either a multi-spectral camera or a hyper-spectral camera, the diffuse spectral intensities of individual particles can be identified with digital image processing methods. In addition, any bubbles can be identified by their circular shapes and strong specular reflections. The spectra of specular reflections are by their nature proportional to the spectrum of the light source and can therefore be used as reference to calculate the relative diffuse spectral reflectances of particles from their individual diffuse spectral intensities. During calibration, a library of reference materials can be built by storing their relative diffuse spectral reflectances in a table on a computer. Afterwards during operation, each spectrograph is identified according to the geometric distance between its relative diffuse spectral reflectance and the closest relative diffuse spectral reflectance of reference materials as stored in such a table. A high enough number of such results are then collated to a statistically significant representation of the bulk slurry solids content material composition.

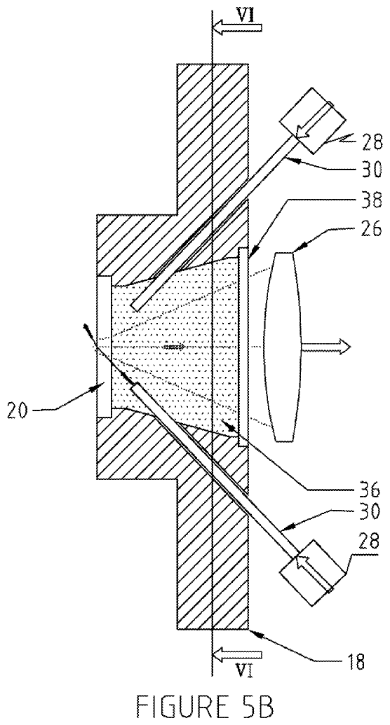

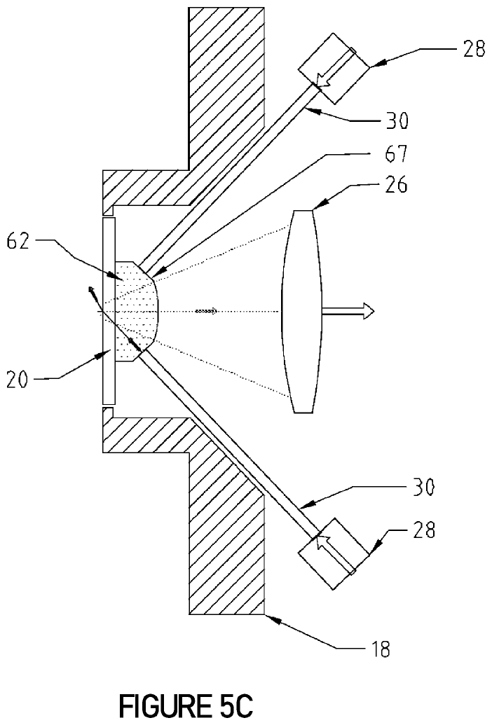

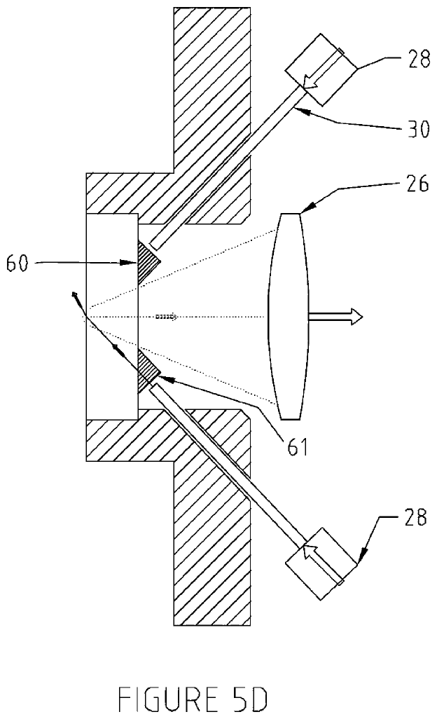

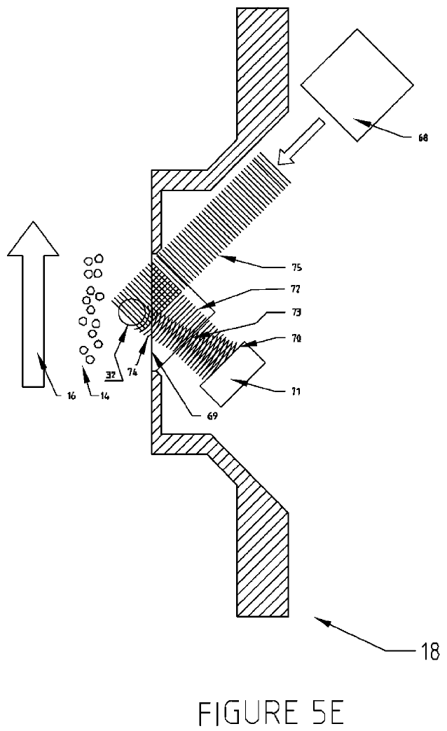

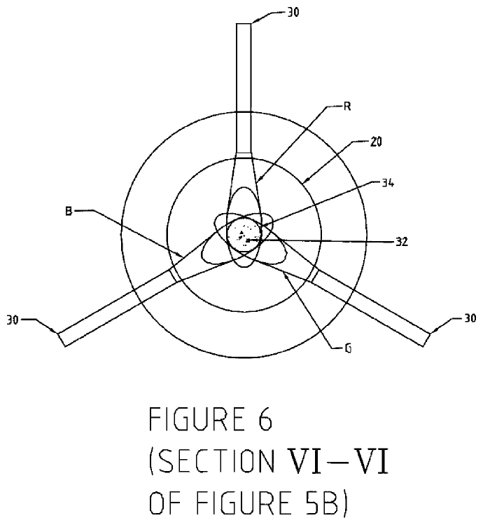

Referring to FIG. 5A, for image processing like for instance colour photometric stereoscopy, it is advantageous to illuminate the examination zone in such a way that the angle between the optical axis of the camera 22 and the optical axis of illumination on the target (solid particle 32 in the examination zone), be maximised. If the angle is too large a significant amount of light may be reflected 59 incorrectly. In a preferred embodiment, a method is proposed to increase this angle past the physical limits that would apply when light travels from the source, through air, through sapphire, through water and onto the target, by replacing the air gap between the illuminating source and the sapphire with an optically clear fluid or solid with a high index of refraction. In the example illustrated in FIG. 5B, this is done by passing the light from the light guides 30 through immersion oil 36 (or alternatively a clear resin with high index of refraction), which is held between the sapphire window 20 and an optical window 38.

In a further preferred embodiment (FIG. 5C), a method is proposed to increase this angle by replacing said air gap with a machinable optical medium with high index of refraction like acrylic 62, machined into a semi-conical shape and polished to achieve close optical contact with the sapphire window 20 and a machined second surface 67, orthogonal to the light direction, to minimise reflection.

In a further preferred embodiment (FIG. 5D), a method is proposed to increase this angle by replacing said air gap with a prism for each light source with one surface 60 that is in close optical contact with the sapphire window 20 and a second surface 61 that is orthogonal to the light direction to minimise reflection.

A further advantage of these methods illustrated in FIGS. 5B to 5D is that the emittance angle of the light source is reduced, narrowing the light beam from the light guide 30 (illuminating fibre). This allows the illuminating source to be placed further from the examination zone and out of the field of view (FOV) of the camera 22.

FIG. 5E shows a coherent monochromatic light source 68 that produces an illuminating beam 75 with a diameter sufficiently large to cover the examination zone and be partially reflected from a prism surface 69 facing the slurry 14 to serve as a reference beam 72 for digital holography where the light reflected 74 from the examination zone and reference beam 72 is collected by a two-dimensional image sensor 71, for instance a CCD, without lenses, to capture the interference patterns 73 from the two beams 72 and 74 for further digital holography signal processing, to produce digital images.

The digital images of the examination zone 34 captured by either the camera 22 or produced from digital holograms captured by the sensor 71, are stored and are analysed on a computer, which identifies individual particles 32 from the slurry 14 in each digital image and determines the sizes of the individual particles from the images. The results of a statistically meaningful number of analysed particles 32 are used and the particle size distribution expressed as a percentage of total solids mass for each predetermined size fraction.

Similarly, the computer determines the shapes of the individual particles 32 from the stored digital images and the results of a statistically meaningful number of analysed particles are used and the particle shape distribution expressed as a percentage of total solids mass for each predetermined particle shape category.

The computer determines the sizes of particles 32 in the stored digital images, in relation to the total area of the examination zone 34 and uses these data to express slurry solids content as percentage solids in relation to total volume.

The computer can also identify and measure bubbles in the stored digital images, due to their spherical shape and specular reflectance, so that the gas contents can be expressed as a fraction or percentage in relation to the total volume of the slurry 14.

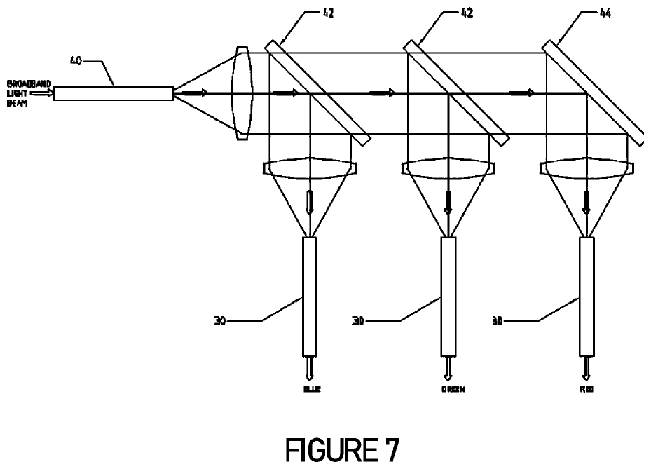

FIG. 7 shows a design for a high efficiency colour separator used to split light emitted from a broadband light source 40 into three different colours by passing the light successively through two dichroic long pass filters 42 and reflecting the remainder from a mirror 44, to launch the three different colours into three separate fibre optic light guides 30.

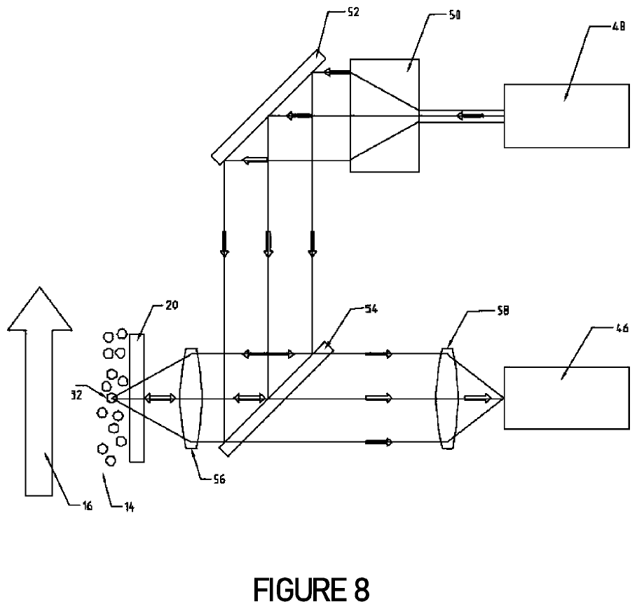

Referring to FIG. 8, in a second embodiment of the present invention, a spectrometer 46 is used to analyse individual solid particles 32 in the slurry 14, instead of using a camera to capture digital images of the solid particles as is done in the first embodiment of the invention, shown in FIGS. 2-7. The same principles are applied in both embodiments of the invention, of a very large number of individual measurements of individual particles 32, each taken over a very short period, with the difference between the two embodiments being the use of digital image analysis to determine particle size and shape in the case of the first embodiment, and spectral analysis of each particle to classify it (determine its contents) in the case of the second embodiment.

The light source used for spectroscopy in the second embodiment is a pulsed light source 48 and the light emitted from the source is passed through a beam expander and collimator 50 and reflected off a mirror 52 and partially reflecting mirror 54, respectively, before being focused on the examination zone by an objective lens assembly 56. Light reflected off or emitted from the examination zone passes through the objective lens assembly 56, passes through the partially reflecting mirror 54 and a focusing lens 58 to the spectrometer 46, for analysis.

In a preferred embodiment, the pulsed light source 48 is a pulsed monochromatic laser, the partially reflecting mirror 54 is either a band pass or a long pass dichroic mirror and the returned light is due to laser induced fluorescence, the Raman Effect or due to light induced breakdown to a plasma state.

In a further preferred embodiment, the pulsed light source 48 is a non-monochromatic light source, for instance a Xenon flash light, the partially reflecting mirror 54 can be a semi-silvered mirror in order to reflect different wavelengths to an equal extent and the returned light is due to diffuse and specular reflectance.

The numerical aperture of the objective lens assembly 56 is preferably used to restrict the depth of field in the part of the examination zone that is being illuminated and measured, i.e. the region around particle 32.

Each resulting spectrograph from the spectrometer 46, whether due to laser induced fluorescence, Raman effect, light induced breakdown, diffuse or specular reflection, is analysed using chemometric methods to identify the most likely material that was in the examination zone of the moving slurry during the time that the spectrograph was taken and then classified as a solid particle type, gas bubble or transporting liquid. A high enough number of spectrographs are analysed to produce a statistically significant representation of the bulk slurry composition.

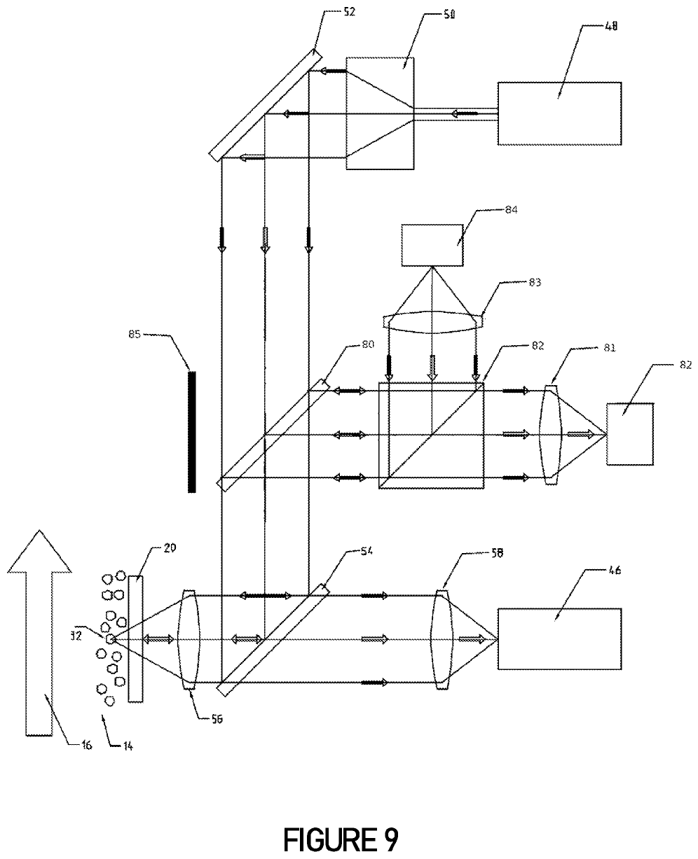

Referring to FIG. 9, the second embodiment of the invention shown in FIG. 8 is further expanded to include a camera 82 with its lens 81, long pass dichroic mirror 80, together with a light source 84, collimating optics 83, beam-splitter 82 and long wavelength absorber 85. In embodiments where the cut-on wavelength of long pass dichroic mirror 54 is chosen to be just above that of the light source 48, the cut-on wavelength of long pass dichroic mirror 80 is chosen to be just below that of the light source 48.

This expansion shown in FIG. 9 adds the ability to image each particle as it receives a shot from light source 48, even though the image is limited to wavelengths shorter than light source 48. The benefit is that more information about each shot is available, for instance whether a particle received a full or partial illumination spot, the size of each analysed particle and the reflectivity of each particle at short wavelengths. This additional information can then be statistically correlated against laboratory analyses of reference slurry samples and such correlations subtracted from the raw results to decrease result bias due to particle size or mineral type. The expansion shown in FIG. 9 also creates no interference with the spectrometer 46, which only receives longer wavelengths of Stokes Raman spectra.

Longer wavelengths than that of light source 48 from light source 84 are transmitted by long pass dichroic mirror 80 and absorbed by a dark absorber 85. Shorter wavelengths than that of light source 48 are reflected by long pass dichroic mirrors 80 and 54 and focused by lens 56 on particle 32. In a preferred embodiment, the light source 84 can be a broadband flash lamp with a lower etendue that of light source 48 which can be a laser, leading to a larger spot size of the short wavelengths from light source 84 than for light source 48. This larger spot size is then imaged through window 20, lens 56, dichroic mirrors 54 and 80, beam splitter 82 and lens 81 onto the photo-sensitive sensor of camera 82. The beam-splitter 82 can be a polarising beam splitter to reduce specular reflection from all optical surfaces in the imaging pathway.

Referring to all of FIGS. 1B to 9, if any of the following principles are not met, the precision and accuracy of results determined by the present invention are affected negatively:
the slurry 14 must flow in the pipe 12 with fully developed turbulence;
the pipe 12 must be straight, smooth and free from disturbances;
the pipe 12 must be close to vertical;
the flowing slurry 14 must fill the entire cross-section of the pipe 12;
the maximum dimension of solid particles 32 in the slurry 14 are less than 2% of the diameter of the pipe 12; and
the window 20 must be flush with the inside of the pipe 12.

The present invention holds the following benefits over the prior art:

a) No sampling error is introduced as no sub-sample is extracted from the flowing slurry 14.
b) No waste produced as no sample is removed from production.
c) No sample handling, sample preparation, sample return or consumables are required.
d) No time delay, as the actual process slurry 14 is analysed in real time and no sub-samples need to be transported or prepared.
e) A low total cost of ownership due to the simplicity of the invention, with no moving parts.
f) No human intervention is required and very little if any maintenance is required.
g) Good detection limits due to measuring a number of small areas and using a robust statistical counting method instead of a sensitive averaging, bulk measure.
h) Smart evaluation of the effect of individual particles 32 in large numbers.
i) A very robust window 20 can be chosen, e.g. sapphire, capable of withstanding high temperature and pressure, chemical corrosion and mechanical abrasion.
j) Turbulent flow keeps the window 20 clean from static material build-up
k) Experimental results showed, contrary to expectations, that the slurry presenting against the window is a good representation of the bulk. Good mixing of the slurry 14 is therefore ensured if the requirements listed above are followed, since any particle 32 has an equal random chance of passing next to the transparent window 20, and presentation bias is removed.

### EXPERIMENTAL VALIDATION

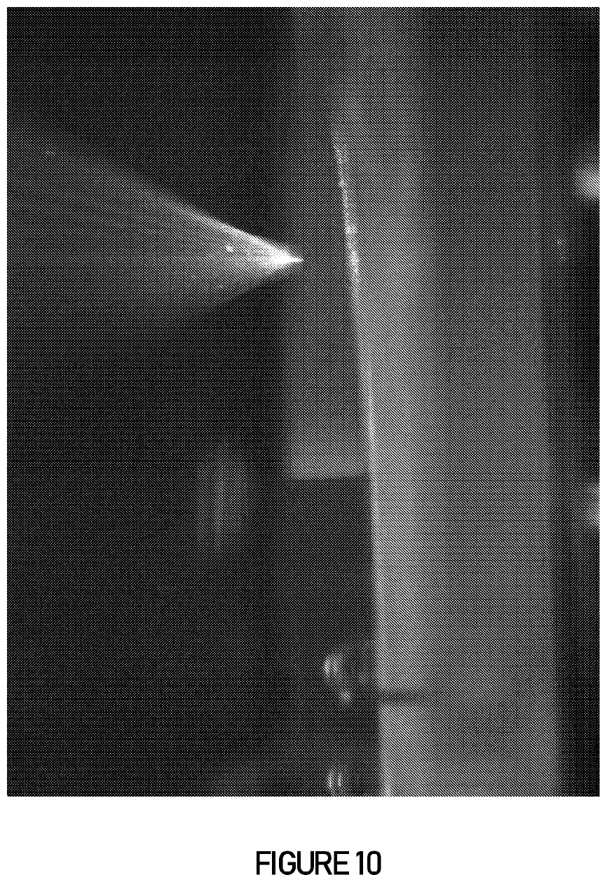

The embodiment of the invention illustrated in FIG. 8 and described herein above was implemented and FIG. 10 shows a side view of the beam of the light source 48 exiting the window 20 into slurry 14. In this case, the light source is a 42 μJ, 532 nm Q-switched laser. The window is a 3 mm thick sapphire window. The image shown in FIG. 10 was taken when the slurry contained only water before any solids were added. The scale of the image is 9.5 mm from left to right.

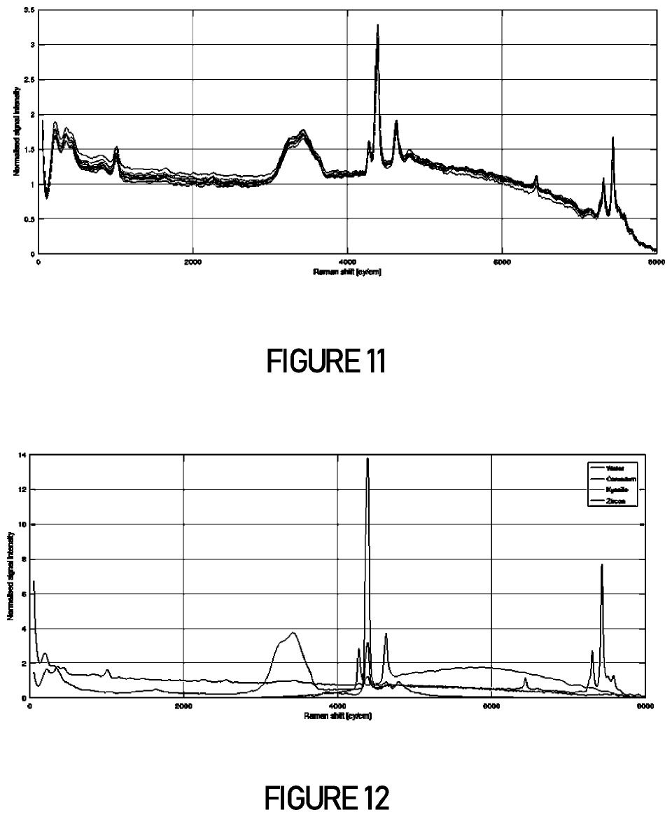

Next, 60 g mineral ore containing Zircon, with several Aluminium Silicates and Aluminium Oxide minerals as impurities, was added to 180 ml water and circulated as a slurry in front of the sapphire window as a turbulent flow. Using a prior art methodology as illustrated in FIG. 1A and described herein above (several mm spot size, integration times of several seconds) the scans shown in FIG. 11 were obtained.

Though the typical Raman signatures for Zircon (1000 cy/cm), water (3700 cy/cm), various Aluminium Silicates and Oxides (4400 cy/cm) are visible, the nature of Raman spectroscopy means that signal intensity is highly variable. Depending on crystal orientation, its signal strength can vary more than an order of magnitude. Therefore, as can be seen in FIG. 11, even with integration times as long as is practical, signal variance is still significant; several percent. Therefore small changes in concentration are undetectable with the prior art method, for Raman spectroscopy quantification.

However, when the present invention as depicted in FIG. 1B and as described herein above was used, more specifically the embodiment shown in FIG. 8 (100 um spot size with 2 ns illumination) distinctive signatures for four types of minerals were obtained in addition to the shots where only water was hit, as shown in FIG. 12.

1-55. (canceled)

56. A method for analysis of a moving slurry of solid particles in a liquid medium, said method comprising:
causing the slurry to flow with fully developed turbulence in a vertical pipe such that the flowing slurry fills the entire cross-section of the pipe;
providing a transparent window in a wall of the pipe, said window being flush with an inside of the pipe;
emitting light from a light source through the window, onto the flowing slurry inside the pipe in an examination zone;
collecting light returned from the examination zone in a lens assembly;
directing the light to a spectrometer with digital output;
analysing the light in the spectrometer to determine a material composition of an individual particle in the examination zone; and
collating the material compositions determined in the spectrometer of a statistically significant number of the individual particles to provide a characteristic material composition of the flowing slurry, as a whole.

57. A method according to claim 56, wherein the light source is pulsed on for short enough periods of time so that a distance of movement of the particles over said time period is less than a maximum expected diameter of said particles.

58. A method according to claim 56, wherein the light collection is integrated for short periods of time so that the distance of movement of particles over said time period is less than a maximum expected diameter of said particles.

59. A method according to claim 56, wherein the light source is directed to the examination zone at an acute angle relative to an axis of light collection.

60. A method according to claim 56, wherein the light source is focused to an area in the examination zone that is smaller than the largest particles expected to be present in the slurry.

61. A method according to claim 56, wherein the light source pulse energy is high enough to cause light induced breakdown of surface of the particles to a state of plasma.

62. A method according to claim 56, wherein the light source is directed through immersion oil to the transparent window in the wall of the pipe.

63. A method according to claim 56, where the light source is directed through an optical medium with high index of refraction, said optical medium being machined and polished to a shape to achieve close optical contact with the transparent window and with a machined second surface orthogonal to the light source direction.

64. A method according to claim 56, wherein each of the light sources is directed through a prism with one surface that is in close optical contact with the transparent window and a second surface orthogonal to the direction of the light source.

65. A method according to claim 56, which includes identifying the material of each particle according to the geometric distance between a relative diffuse spectral reflectance and a closest relative diffuse spectral reflectance of reference materials, and collating a sufficiently high number of results to a statistically significant representation of the bulk slurry solids content material composition.

66. A method according to claim 56, which includes directing the light from the light source and light returned from the examination zone co-axially in opposite directions and separating them by use of a partially reflecting mirror at an acute angle to the average light axis.

67. A method according to claim 66, which includes taking a plurality of consecutive digital spectrographs of an examination zone in the flowing slurry and analysing each digital spectrograph with chemometric methods to identify the most likely material that was in the examination zone during the time that the spectrograph was taken and then classifying the result as a solid particle type, gas bubble or transporting liquid for a sufficiently high number of measurements to produce a statistically significant representation of the bulk slurry composition.

68. A method according to claim 66, wherein the total fraction of spectrographs classified as solids particles is calculated and the result then serves as a monotonically rising indicator of the fraction of solids in the slurry.

69. A method according to claim 66, which includes using a wavelength area that is shorter than the primary light source wavelength in a Stokes Raman analyser, by adding a long pass dichroic mirror with a cut-on wavelength below that of the primary light source, into the primary light source path.

70. A method according to claim 69, which includes adding a lens camera behind said long pass dichroic mirror, said lens camera being configured to capture an image of the analysis area.

71. A method according to claim 69 which includes providing a polarised beam splitter and secondary collimated light source that are configured to emit wavelengths that include wavelengths that are shorter than the wavelengths of the primary light source, in order to illuminate the area of analysis.

72. A method according to claim 71, wherein the secondary light source has an etendue that is lower than the primary light source, in order to increase its spot size at the examination zone.

73. A method according to claim 71, which includes using a secondary light source with a slightly unfocussed collimator in order to increase its spot size at the examination zone.

74. Apparatus for analysis of a moving slurry of solid particles in a liquid medium, said apparatus comprising:
a transparent window that is flush with an inside of a wall of a vertical pipe
a light source that is configured to emit light from an outside of the window, through the window, onto a slurry flowing inside the pipe in an examination zone;
a spectrometer disposed on the same side of the moving slurry as the light source, said spectrometer being configured for determining a material composition of a plurality of individual solid particles in the flowing slurry by collecting analysing light returned from the individual solid particles in the examination zone; and
a processor configured for collating the material compositions determined in the spectrometer of a statistically significant number of the individual particles to provide a characteristic material composition of the flowing slurry, as a whole.

75. A method for analysis of a moving slurry of solid particles in a liquid medium, said method comprising:
causing the slurry to flow with fully developed turbulence in a vertical pipe such that the flowing slurry fills the entire cross-section of the pipe;
providing a transparent window in a wall of the pipe, said window being flush with an inside of the pipe;
emitting light from a light source through the window, onto the flowing slurry inside the pipe in an examination zone;
taking a plurality of individual measurements of individual solid particles in the flowing slurry by collecting light returned from the examination zone; and
collating the results of a statistically significant number of the individual measurements to provide a characteristic of the flowing slurry, as a whole
said method including obtaining a multi-spectral image and determining the spectral intensities of the light source from the specular reflectance off bubbles, to serve as reference spectral intensities and calculating relative diffuse spectral reflectance for individual particles.
